(19) United States
(12) Patent Application Publication
(10) Pub. No.: US 2006/0056342 A1
(43) Pub. Date: Mar. 16, 2006

(54) Monitoring paging channel of packet switched service

(75) Inventor: Sung Kyu Lee, Gyeonggi-Do (KR)

Correspondence Address: JONATHAN Y. KANG ESQ.;LEE, HONG, DEGERMAN, KANG & SCHMADEKA, P.C., 14th Floor, 801 S Figueroa Street, Los Angeles, CA, 90017, US

(73) Assignee: LG Electronics Inc.

(21) Appl. No.: 11/229,392

(22) Filed: Sep. 15, 2005

(30) Foreign Application Priority Data
Sep. 16, 2004 (KR) 2004-0074290

(51) Int. Cl. H04Q 7/00

(52) U.S. Cl. 370/328

(57) ABSTRACT

The present invention is related to monitoring a paging channel of a packet-switched service in a mobile terminal of a mobile communication system. The present invention monitors a circuit-switched (CS) paging channel when a General Packet Radio Service (GPRS) mode is changed to a packet transfer mode. While monitoring the CS paging channel, if a mobile communication network is determined to be a test network, the CS paging channel monitoring is stopped. If the mobile communication network is a real network, monitoring of the CS paging channel is controlled according to a type of the real network.

### CROSS-REFERENCE TO RELATED APPLICATIONS

Pursuant to 35 U.S.C. § 119(a), this application claims the benefit of earlier filing date and right of priority to Korean Application No. 2004-74290, filed on Sep. 16, 2004, the contents of which is hereby incorporated by reference herein in its entirety.

### FIELD OF THE INVENTION

The present invention relates to a packet-switched service such as a General Packet Radio Service (GPRS) and, more particularly, to a method for monitoring a paging channel of the packet-switched service.

### BACKGROUND OF THE INVENTION

As a multimedia communication service develops into full scale, services that simultaneously use a GPRS channel and a Global System for Mobile communication (GSM) channel, such as an Multimedia Messaging Service (MMS), an Instant Messaging (IM) service, a Push To Talk (PTT) service, and the like are increasing. Accordingly, the importance of a monitoring process for circuit switched (CS) paging during packet data transmission is increasing. Moreover, mobile communication service providers are increasingly requesting the monitoring process for the circuit switched paging.

Most mobile communication networks are operated in a network operation mode II. A class B mobile terminal must monitor a CS paging channel during packet data transmission. Without monitoring the CS paging channel during packet data transmission, the mobile terminal cannot receive a Mobile Terminated (MT) voice call and a Short Message Service (SMS) message during packet data transmission. Namely, if the class B mobile terminal fails to monitor the CS paging channel, it cannot satisfy service requirements requested for a multimedia communication service.

Meanwhile, when the mobile terminal monitors the CS paging channel periodically regardless of the network type, the packet data throughput can be degraded or data transmission can be abnormally disconnected depending on the network type (network environment).

### SUMMARY OF THE INVENTION

The present invention is directed to monitoring a paging channel of a packet-switched service.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for monitoring a paging channel of a packet-switched service in a mobile terminal of a mobile communication system, the method comprising determining a type of mobile communication network the mobile terminal is connected to, and controlling monitoring of the paging channel based on the type of mobile communication network. Preferably, the paging channel is a circuit-switched (CS) paging channel.

In one aspect of the invention, the step of controlling monitoring of the paging channel comprises monitoring the paging channel when a General Packet Radio Service (GPRS) mode is changed to a packet transfer mode.

In another aspect, the step of controlling monitoring of the paging channel comprises stopping the monitoring of the paging channel when the mobile communication network is a test network.

In a further aspect, the step of controlling monitoring of the paging channel comprises controlling monitoring of the paging channel according to a type of a real network, when the mobile communication network is the real network. Preferably, the step of controlling monitoring of the paging channel according to the type of the real network comprises monitoring the paging channel when the real network supports scheduling of a packet traffic channel (PTCH) and a common control channel (CCCH), and checks for communication link establishment through re-transmission of data one or more times.

Moreover, the step of controlling monitoring of the paging channel according to the type of the real network comprises stopping the monitoring of the paging channel when the real network does not support the scheduling of the PTCH and the CCCH and checks for the communication link establishment through only one data transmission.

Preferably, the type of mobile communication network is determined by checking a mobile network code (MNC)/mobile country code (MCC) of the mobile communication network. The mobile communication network may be one of a test network and a real network.

In accordance with another embodiment of the present invention, a method for monitoring a paging channel of a packet-switched service in a mobile terminal of a mobile communication system comprises monitoring a paging channel of the mobile communication network when a General Packet Radio Service (GPRS) mode is changed to a packet transfer mode, stopping the monitoring of the paging channel when the mobile communication network is a test network, and controlling monitoring of the paging channel according to a type of a real network, when the mobile communication network is the real network. Preferably, the paging channel is a circuit-switched (CS) paging channel.

In one aspect of the invention, the step of controlling monitoring of the CS paging channel comprises monitoring the CS paging channel when the real network supports scheduling of a packet traffic channel (PTCH) and a common control channel (CCCH) and checks for communication link establishment through re-transmission of data one or more times.

In another aspect, the step of controlling monitoring of the CS paging channel comprises stopping the monitoring the CS paging channel when the real network does not support the scheduling of the PTCH and the CCCH and checks for the communication link establishment through only one data transmission.

In a further aspect, the step of controlling monitoring of the CS paging channel comprises at least one of checking whether the real network supports the scheduling of a packet traffic channel (PTCH) and a common control channel (CCCH) and checking whether data transmission has been abnormally terminated.

Preferably, the method further comprises checking whether the mobile communication network is the test network or the real network by checking a mobile network code (MNC)/mobile country code (MCC) of the mobile communication network.

In accordance with another embodiment of the present invention, a method for monitoring a paging channel of a packet-switched service in a mobile terminal of a mobile communication system comprises monitoring a circuit-switched (CS) paging channel of a mobile communication network when a General Packet Radio Service (GPRS) mode is changed to a packet transfer mode, checking whether the mobile communication network is a real network or a test network while the CS paging channel is being monitored, stopping the monitoring of the CS paging channel when the mobile communication network is a test network, setting or resetting a flag for determining whether to monitor the CS paging channel according to an operational type of a real network, when the mobile communication network is the real network, stopping the monitoring of the CS paging channel when the flag is set, and monitoring the CS paging channel when the flag is reset.

Preferably, in the step of setting or resetting the flag, the flag is set or reset by at least one of checking whether the real network supports scheduling of a packet traffic channel (PTCH) and a common control channel (CCCH), and checking whether a data transmission has been abnormally terminated.

Preferably, the step of setting or resetting the flag comprises resetting the flag with a default value when the mobile terminal is initialized, resetting the flag when a routing area code is changed, and setting the flag when data transmission is abnormally terminated after a packet channel is released.

Preferably, in the step of checking whether the mobile communication network is the real network or the test network, the mobile communication network is determined to be the test network or the real network by checking a mobile network code (MNC)/mobile country code (MCC) of the mobile communication network.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a block diagram illustrating a General Packet Radio Service (GPRS) logical architecture.

FIG. 2 is a state diagram illustrating transitions between operated states of a GPRS mode.

FIG. 3 is a diagram illustrating a channel occupancy time in accordance with monitoring a packet traffic channel (PTCH) and a common control channel (CCCH) in a mobile terminal that does not monitor a CS paging channel in a packet transfer mode.

FIG. 4 is a diagram illustrating a channel occupancy time in accordance with monitoring the PTCH and the CCCH in the mobile terminal that monitors the CS paging channel in the packet transfer mode.

FIG. 5 is a flow chart illustrating an update of a network check block parameter in accordance with one embodiment of the present invention.

FIG. 6 is a flow chart illustrating a method for monitoring a paging channel of a packet-switched service in accordance with one embodiment of the present invention.

### DETAILED DESCRIPTION OF THE PREFERRED EMBODIMENTS

The present invention relates to monitoring a paging channel of a packet-switched service.

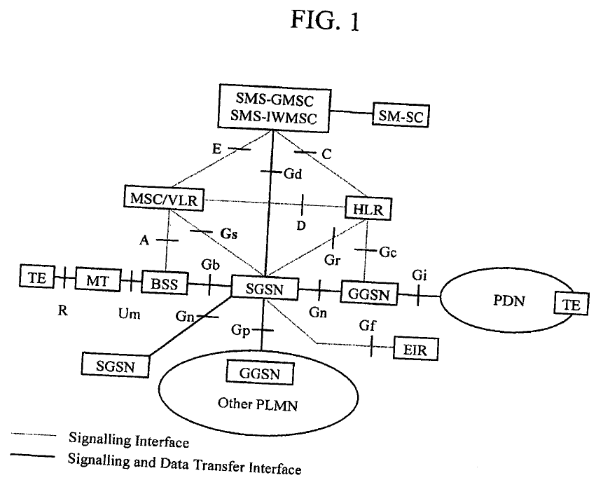

In accordance with one embodiment of the present invention, a method for effectively monitoring a paging channel of a circuit-switched (CS) service according to a network type when a GPRS mode is changed to a packet transfer mode, namely, during a packet-switched (PS) service will be described with reference to FIGS. 1 to 6.

FIG. 1 is a block diagram illustrating a General Packet Radio Service (GPRS) logical architecture. A GPRS network comprises a serving GPRS support node (SGSN) connected with a mobile communication network. The SGSN is also connected with a packet data network (PDN) via a gateway GPRS support node (GGSN).

The SGSN exchanges information with a mobile switching center (MSC)/visitor location register (VLR), a short message switching center (SMSC) and a home location register (HLR) of the mobile communication network through data transfer and signaling interfaces.

The GGSN performs data communication with public land mobile networks (PLMN) other than the mobile communication network, and connects the mobile communication network with the PLMN.

The mobile communication network may provide paging coordination for the circuit-switched (CS) service and the packet-switched (PS) service. The paging coordination, which employs the same channel as the channel used for the PS service, comprises transmitting a paging message for the CS service. The mobile terminal can monitor two channels, a CS paging channel and a PS paging channel, in the network supporting the paging coordination.

Network operation modes include network operation modes I, II and III. Different paging channels are used for the CS paging channel and the GPRS paging channel according to the network operation mode. In addition, paging coordination is either supported or not supported according to the network operation mode. Table 1 shows paging channels used and whether paging coordination is supported or not supported according to each network operation mode.

TABLE 1

| | CIRCUIT PAGING | GPRS PAGING | PAGING |
|---|---|---|---|
| MODE | CHANNEL | CHANNEL | COORDINATION |
| I | Packet paging | Packet paging | Yes |
| | channel | channel | |
| | CCCH paging | CCCH paging | |
| | channel | channel | |
| | Packet data | Not applicable | |
| | channel | | |
| II | CCCH paging | CCCH paging | No |
| | channel | channel | |
| III | CCCH paging | Packet paging | No |
| | channel | channel | |
| | CCCH paging | CCCH paging | |
| | channel | channel | |

A CCCH (Common Control Channel) paging channel is a standard control channel used by the GSM network for establishing a communication link between a mobile terminal and a base station.

In network operation mode I, CS paging messages are transmitted through the same channel as used for the GPRS paging channel. Thus, the mobile terminal monitors one paging channel in network operation mode I. When a packet data channel is allocated, the mobile terminal receives the CS paging message through the allocated packet data channel.

In network operation mode II, CS paging messages are transmitted through the CCCH. The CCCH paging channel is used for paging the GPRS. Although the mobile terminal monitors the CCCH paging channel in network operation mode II, when the mobile terminal allocates the packet data channel, the CS paging is continued through the CCCH paging channel. Accordingly, in network operation mode II, two channels, namely, the CS paging channel and the PS paging channel must be simultaneously monitored during data transmission.

In network operation mode III, CS paging messages are transmitted through the CCCH paging channel. GPRS paging messages are transmitted through the packet paging channel and the CCCH paging channel. Thus, when the packet paging channel is allocated to a cell, the mobile terminal must monitor the CS paging channel and the PS paging channel.

Network operation mode II is mostly used in the real network, which, however, does not support the paging coordination. Therefore, the mobile terminal must monitor the CS paging channel during data transmission.

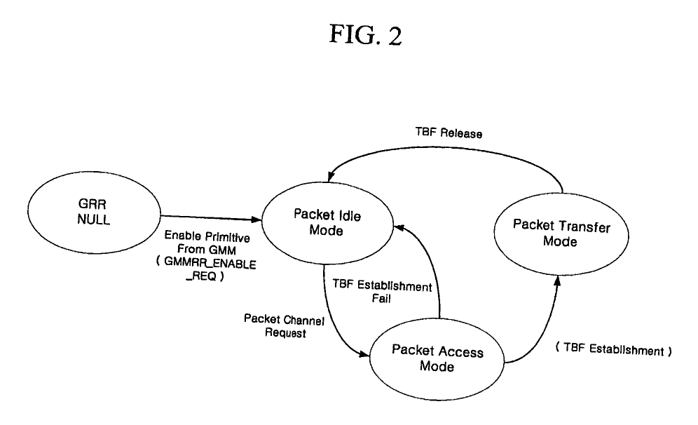

FIG. 2 illustrates transitions of operational states in a GPRS network. When GPRS mobility management (GMM) starts in the GPRS mode, the GPRS network mode is changed to a packet idle mode, the packet idle mode is changed to a packet access mode, and the packet access mode is changed to a packet transfer mode according to the establishment of a temporary block flow (TBF). When the TBF is released, the packet transfer mode is returned to a packet idle mode. Herein, if the TBF establishment fails in the packet access mode, the packet access mode is changed to the packet idle mode.

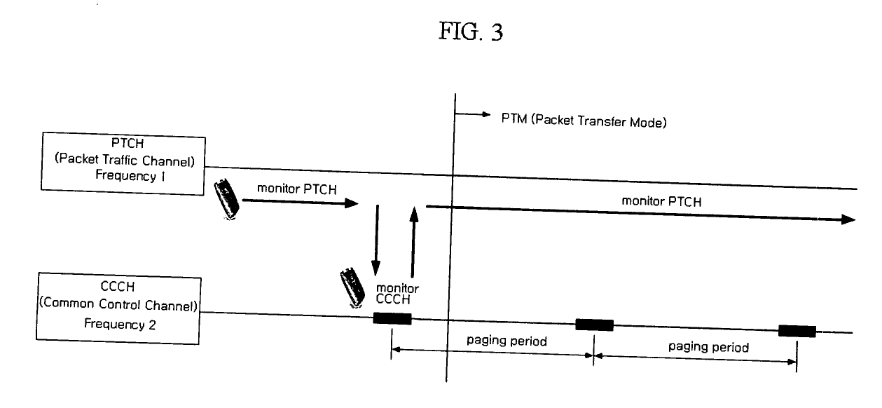

FIG. 3 is a diagram illustrating a channel occupancy time in accordance with monitoring a packet traffic channel (PTCH) and a common control channel (CCCH) in a mobile terminal that does not monitor a CS paging channel in a packet transfer mode.

The mobile terminal, which does not monitor the CS paging channel in the packet transfer mode, monitors the PTCH after the packet transfer mode. Accordingly, compared with the mobile terminal that monitors the paging time and the CS paging channel, the data throughput may become as fast as the time taken for re-transmitting an acknowledgement message request signal when the acknowledgement message is not received. However, the mobile terminal which does not monitor the CS paging channel cannot cope with a case where a communication provider or a new service requests the CS paging.

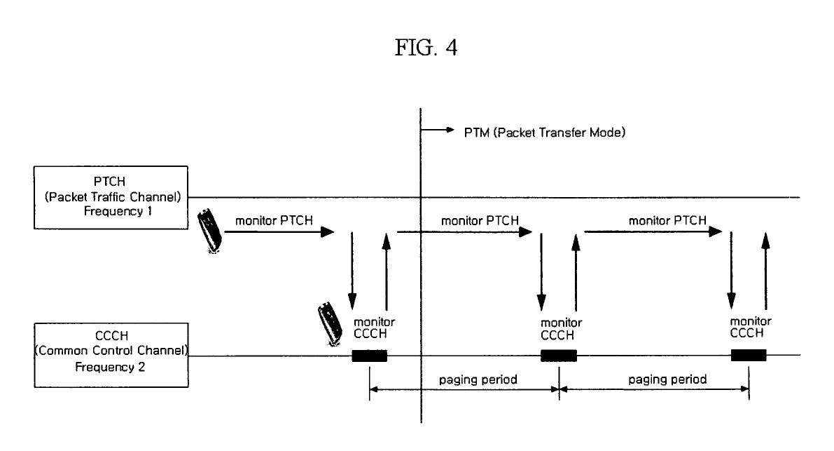

FIG. 4 is a diagram illustrating a channel occupancy time in accordance with monitoring the PTCH and the CCCH in the mobile terminal that monitors the CS paging channel in the packet transfer mode.

The mobile terminal, which monitors the CS paging channel in the packet transfer mode, awakens at every paging period of a paging group to which the mobile terminal belongs during a DRX (Discontinuous Reception Operation) of the packet transfer mode to monitor the PTCH. During DRX, the mobile terminal is asleep except during an interval where data is transmitted. While the mobile terminal monitors the CCCH channel, it cannot monitor the PTCH. Thus, if an acknowledge message is transmitted, the mobile terminal fails to receive the acknowledge message. Accordingly, the mobile terminal re-transmits data. Moreover, if the mobile terminal normally receives a poll request message in response to which it is to transmit a packet control acknowledgement (PCA) message but fails to transmit the PCA message, data transfer may be disconnected according to a network implementation. Typically, a network schedules a message on the CCCH and the PTCH so as not to cause the disconnection phenomenon. In this respect, although the network does not schedule the message, the communication link (GPRS link) cannot be disconnected just because the mobile terminal fails to transmit the PCA message one time.

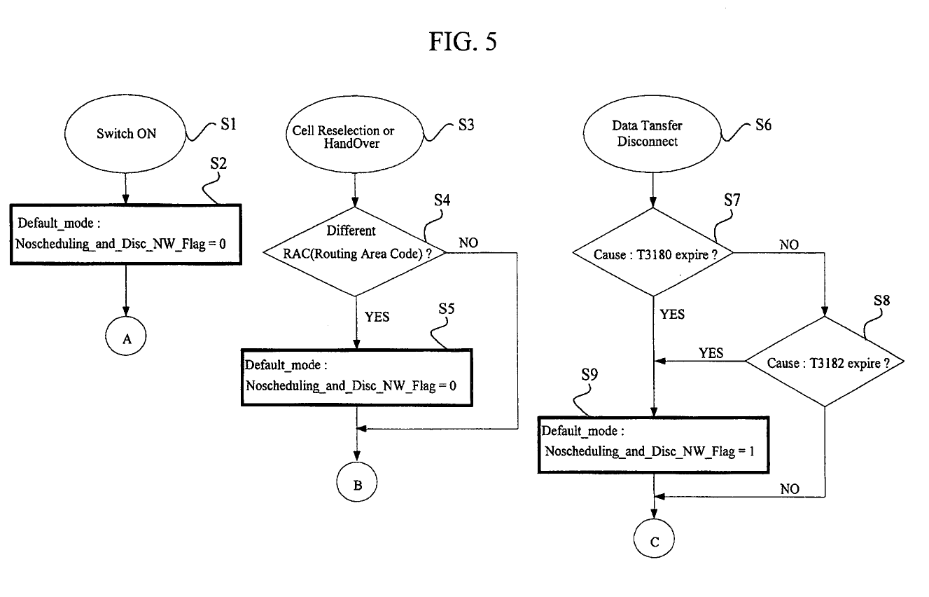

FIG. 5 is a flow chart illustrating an update of a network check block parameter in accordance with one embodiment of the present invention. Specifically, FIG. 5 illustrates a process of detecting whether a network with which the mobile terminal is interfaced schedules the CS paging channel.

As shown in FIG. 5, the operation of updating the network check block parameter comprises resetting a no-scheduling flag of a mobile terminal with a default value when the mobile terminal is initialized; resetting the no-scheduling flag when a cell is re-selected or a routing area code (RAC) such as handover is changed; and setting the no-scheduling flag when data transmission is disconnected after a packet channel is released.

The no-scheduling flag is a network check block parameter and a flag for determining whether to monitor the CS paging channel. Accordingly, resetting the no-scheduling flag indicates monitoring of the CS paging channel, and setting of the no-scheduling flag indicates no monitoring of the CS paging channel.

First, when the mobile terminal is initialized (switch ON) (step S1), the mobile terminal resets the network check block parameter with a default value. Namely, when power is supplied to the mobile terminal, the mobile terminal is initialized and resets the no-scheduling flag with the default value to finish initialization of the network check (No-scheduling_and_Disc_NW_Flag=0) (step S2).

When a cell is changed according to re-selection of a cell and handover (step S3), if the RAC and the network type are changed (step S4), the mobile terminal resets the no-scheduling flag (No-scheduling_and_Disc_NW_Flag=0) (step S5).

When data transmission is disconnected after the packet channel release or when data transmission is normally terminated according to a protocol timer T3190 expiration, the mobile terminal resets the no-scheduling flag. Meanwhile, when the data transmission is disconnected after the packet channel release (step S6) or when data transmission is abnormally terminated according to protocol timer T3180/T3182 expiration (steps S7 and S8), the mobile terminal sets the no-scheduling flag to give priority to maintaining the communication link (GPRS link) and data transmission (No-scheduling_and_Disc_NW_Flag=1) (step S9).

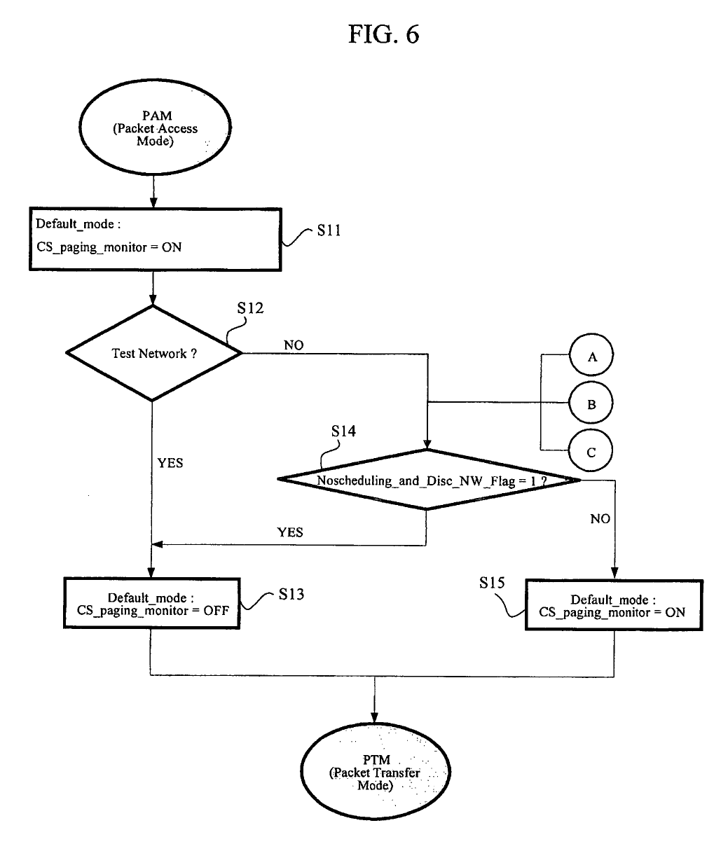

FIG. 6 is a flow chart illustrating a method for monitoring a paging channel of a packet-switched service in accordance with one embodiment of the present invention. As shown in FIG. 6, the method for monitoring a paging channel of the packet-switched service comprises monitoring a circuit-switched paging channel when a GPRS mode is changed from a packet access mode to a packet transfer mode (CS_paging_monitor=ON); checking whether a mobile communication network, with which the mobile terminal is interfaced, is a test network or a real network while the CS paging channel is being monitored. If the mobile communication network is the test network, the CS paging channel is no longer monitored (CS_paging_monitor=OFF).

If the mobile communication network is the real network, the method comprises checking whether the real network supports scheduling of a packet traffic channel (PTCH) and a CCCH, checking whether data transmission has been abnormally terminated, setting or resetting a no-scheduling flag of the mobile terminal, monitoring the CS paging channel if the no-scheduling flag is set, and monitoring the CS paging channel if the no-scheduling flag is reset.

First, when the GPRS mode is changed from the packet access mode to the packet transfer mode, the mobile terminal monitors the CS paging channel (CS_paging_monitor=ON) (step S11).

Thereafter, the mobile terminal checks whether its mobile communication network is a test network or a real network (step S12). If the mobile communication network is a test network, the mobile terminal does not monitor the CS paging channel (CS_paging_monitor=OFF) (step S13).

The test network is a network (i.e., virtual network) for testing the operation of the mobile terminal for GCF (Global Certification Forum)/PTCRB (PCS Type Certification Review Board) testing through testing equipment such as HP8960/CMU200. When the mobile terminal is tested, the mobile terminal does not monitor the circuit-switched paging channel for a stable data transmission and testing. The mobile terminal can determine whether the mobile communication network is the test network or the real network by checking the value of a mobile network code/mobile country code (MNC/MCC), i.e., “network code group”. For example, the test network may unconditionally set the value of MNC/MCC as “00101” which is received from testing usage, whereas a real network uses a determined MNC/MCC. Accordingly, the mobile terminal can thereby easily determine whether the mobile communication network is the test network or a real network based on the value of the MNC/MCC network code group transmitted as network system information.

In addition, in case of the test network, the mobile terminal may be designed with a default mode such that the mobile terminal does not monitor the CS paging channel due to an implementation issue. Thus, the test network may not support (i.e., emulate) scheduling of the PTCH and the CCCH.

Accordingly, the mobile terminal determines whether the mobile communication network is the test network or the real network according to the value of the MNC/MCC contained in system information received over the network interface. If the mobile communication network is the real network, the mobile terminal determines in which type the real network operates.

If the mobile communication network is the real network and the no-scheduling flag is reset (No-scheduling_and_Disc_NW_Flag=0), the mobile terminal monitors the CS paging channel (CS_paging_monitor=ON) (steps S14 and S15). If, however, the mobile communication network is the real network and the no-scheduling flag is set (No-scheduling_and_Disc_NW_Flag=1), the mobile terminal does not monitor the circuit-switched paging channel (CS_paging_monitor=OFF) (step S13).

Preferably, the mobile terminal checks whether the real network is a network supporting scheduling between the PTCH and the CCCH. The mobile terminal also checks whether the network checks for link establishment through re-transmission of data one or more times with reference to the no-scheduling flag, which has been updated through the update operation of the network check block parameter as described above. Accordingly, the CS paging channel is either monitored or not monitored.

For example, if the real network supports scheduling between the PTCH and the CCCP and checks for the link establishment through re-transmission of data one or more times, the mobile terminal can receive an MT (Mobile Terminated) voice call or an SMS message during data transmission by monitoring the CS paging channel. Preferably, the service requirements requested for performing a multimedia service can be satisfied.

Meanwhile, if the real network does not support scheduling between the PTCH and the CCCH and checks for the link establishment through only one data transmission, the mobile terminal does not monitor the circuit-switched paging channel. Thus, a worst case scenario wherein data transmission is disconnected is thereby avoided.

As so far described, the method for monitoring the paging channel of the packet-switched service has the following advantages. By monitoring the CS paging channel according to a network type in the packet transfer mode, the mobile terminal can receive an MT voice call and an SMS message during packet data transmission, the data throughput can be enhanced, and the phenomenon of data transmission being abnormally disconnected can be prevented.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embrace by the appended claims.

What is claimed is:

1. A method for monitoring a paging channel of a packet-switched service in a mobile terminal of a mobile communication system, the method comprising:
determining a type of mobile communication network the mobile terminal is connected to; and
controlling monitoring of the paging channel based on the type of mobile communication network.

2. The method of claim 1, wherein the paging channel is a circuit-switched (CS) paging channel.

3. The method of claim 1, wherein the step of controlling monitoring of the paging channel comprises:
monitoring the paging channel when a General Packet Radio Service (GPRS) mode is changed to a packet transfer mode.

4. The method of claim 1, wherein the step of controlling monitoring of the paging channel comprises:
stopping the monitoring of the paging channel when the mobile communication network is a test network.

5. The method of claim 1, wherein the step of controlling monitoring of the paging channel comprises:
controlling monitoring of the paging channel according to a type of a real network, when the mobile communication network is the real network.

6. The method of claim 5, wherein the step of controlling monitoring of the paging channel according to the type of the real network comprises:
monitoring the paging channel when the real network supports scheduling of a packet traffic channel (PTCH) and a common control channel (CCCH), and checks for communication link establishment through re-transmission of data one or more times.

7. The method of claim 6, wherein the step of controlling monitoring of the paging channel according to the type of the real network comprises:
stopping the monitoring of the paging channel when the real network does not support the scheduling of the PTCH and the CCCH and checks for the communication link establishment through only one data transmission.

8. The method of claim 1, wherein the type of mobile communication network is determined by checking a mobile network code (MNC)/mobile country code (MCC) of the mobile communication network.

9. The method of claim 1, wherein the mobile communication network is one of:
a test network; and
a real network.

10. A method for monitoring a paging channel of a packet-switched service in a mobile terminal of a mobile communication system, the method comprising:
monitoring a paging channel of the mobile communication network when a General Packet Radio Service (GPRS) mode is changed to a packet transfer mode;
stopping the monitoring of the paging channel when the mobile communication network is a test network; and
controlling monitoring of the paging channel according to a type of a real network, when the mobile communication network is the real network.

11. The method of claim 10, wherein the paging channel is a circuit-switched (CS) paging channel.

12. The method of claim 11, wherein the step of controlling monitoring of the CS paging channel comprises:
monitoring the CS paging channel when the real network supports scheduling of a packet traffic channel (PTCH) and a common control channel (CCCH) and checks for communication link establishment through re-transmission of data one or more times.

13. The method of claim 12, wherein the step of controlling monitoring of the CS paging channel comprises:
stopping the monitoring the CS paging channel when the real network does not support the scheduling of the PTCH and the CCCH and checks for the communication link establishment through only one data transmission.

14. The method of claim 11, wherein the step of controlling monitoring of the CS paging channel comprises at least one of:
checking whether the real network supports the scheduling of a packet traffic channel (PTCH) and a common control channel (CCCH); and
checking whether data transmission has been abnormally terminated.

15. The method of claim 10, further comprising:
checking whether the mobile communication network is the test network or the real network by checking a mobile network code (MNC)/mobile country code (MCC) of the mobile communication network.

16. A method for monitoring a paging channel of a packet-switched service in a mobile terminal of a mobile communication system, the method comprising:
monitoring a circuit-switched (CS) paging channel of a mobile communication network when a General Packet Radio Service (GPRS) mode is changed to a packet transfer mode;
checking whether the mobile communication network is a real network or a test network while the CS paging channel is being monitored;
stopping the monitoring of the CS paging channel when the mobile communication network is a test network;
setting or resetting a flag for determining whether to monitor the CS paging channel according to an operational type of a real network, when the mobile communication network is the real network;
stopping the monitoring of the CS paging channel when the flag is set; and
monitoring the CS paging channel when the flag is reset.

17. The method of claim 16, wherein in the step of setting or resetting the flag, the flag is set or reset by at least one of:
checking whether the real network supports scheduling of a packet traffic channel (PTCH) and a common control channel (CCCH); and
checking whether a data transmission has been abnormally terminated.

18. The method of claim 16, wherein the step of setting or resetting the flag comprises:
resetting the flag with a default value when the mobile terminal is initialized;
resetting the flag when a routing area code is changed; and
setting the flag when data transmission is abnormally terminated after a packet channel is released.

19. The method of claim 16, wherein, in the step of checking whether the mobile communication network is the real network or the test network, the mobile communication network is determined to be the test network or the real network by checking a mobile network code (MNC)/mobile country code (MCC) of the mobile communication network.
